(19) United States
(12) Patent Application Publication
(10) Pub. No.: US 2023/0266765 A1
(43) Pub. Date: Aug. 24, 2023

(54) PREDICAMENT AVOIDANCE METHOD, AUTONOMOUS MOBILE DEVICE, AND STORAGE MEDIUM

(71) Applicant: Qfeeltech (Beijing) Co., Ltd., Beijing (CN)

(72) Inventors: Xin WU, Beijing (CN); Zhanglin LIU, Beijing (CN); Yiming ZHANG, Beijing (CN); Zhen CHEN, Beijing (CN)

(21) Appl. No.: 18/309,758

(22) Filed: Apr. 28, 2023

Related U.S. Application Data
(63) Continuation of application No. PCT/CN2021/122429, filed on Sep. 30, 2021.

(30) Foreign Application Priority Data
Oct. 30, 2020 (CN) 202011198040.3

(51) Int. Cl. G05D 1/02; G01C 21/00

(52) U.S. Cl. CPC G05D 1/0214; G05D 1/0274; G01C 21/3815; G01C 21/3837; G05D 2201/0203

(57) ABSTRACT

A method for avoiding a predicament, the method being implemented in an autonomous mobile device. The method includes obtaining a map of a work zone, and moving the autonomous mobile device in the work zone. The method also includes obtaining sensed information acquired by at least one sensor of the autonomous mobile device, the sensed information being usable to obtain an environmental state of a first location of the autonomous mobile device when the sensed information is acquired, or an environmental state of a second location having a detecting distance from the first location of the autonomous mobile device when the sensed information is acquired. The method also includes determining, based on the sensed information, that the environmental state of the first location or the second location is a predicament; and determining the first location or the second location corresponding to the predicament as a dangerous location.

### CROSS-REFERENCE TO RELATED APPLICATIONS

This application is a continuation of International Patent Application No. PCT/CN2021/122429, filed on Sep. 30, 2021, which claims priority to Chinese Patent Application No. 202011198040.3, filed on Oct. 30, 2020, in Chinese Patent Office, titled “Predicament Avoidance Method, Autonomous Mobile Device and Storage Medium.” The entire content of the above-mentioned applications is incorporated herein by reference.

### TECHNICAL FIELD

The present disclosure generally relates to the technical field of intelligent controls and, more specifically, to a predicament avoidance method, an autonomous mobile device, and a storage medium.

### BACKGROUND

As technologies advance, more and more autonomous mobile devices equipped with various functions entered people's daily life, to provide more convenience to people.

An autonomous mobile device normally moves on a floor of a limited space to perform various tasks. The floor in the limited space may be called a work zone of the autonomous mobile device. The environment of the work zone for different types of autonomous mobile devices may be different. For many autonomous mobile devices, the environment in the work zone is complex, which may include obstacles that hinder the operation of the autonomous mobile device.

In related technologies, during the movement, the autonomous mobile device cannot avoid the obstacles effectively, which may cause the termination of the operation, reduce the work efficiency of the autonomous mobile device, and even damage the device.

### SUMMARY OF THE DISCLOSURE

The present disclosure provides a predicament avoidance method, an autonomous mobile device, and a storage medium. The autonomous mobile device may autonomously recognize an obstacle that the device may encounter, and construct a dangerous zone. During movement, the autonomous mobile device may avoid the dangerous zone to reduce or even avoid the situation of being blocked by the obstacle, such that the work efficiency can be improved.

In a first aspect, the present disclosure provides a predicament avoidance method, implemented in an autonomous mobile device, the method including:

obtaining a map of a work zone;

moving the autonomous mobile device in the work zone;

obtaining sensed information acquired by at least one sensor of the autonomous mobile device, the sensed information being usable to obtain an environmental state of a first location of the autonomous mobile device when the sensed information is obtained, or an environmental state of a second location having a detecting distance from the first location of the autonomous mobile device when the sensed information is obtained;

determining, based on the sensed information, whether the environmental state of the first location of the autonomous mobile device when the sensed information is obtained is a predicament, or whether the environmental state of the second location having the detecting distance from the first location of the autonomous mobile device when the sensed information is obtained is a predicament;

based on a determination that the environmental state of the first location of the autonomous mobile device when the sensed information is obtained is a predicament, or that the environmental state of the second location having the detecting distance from the first location of the autonomous mobile device when the sensed information is obtained is a predicament, determining that the first location or the second location corresponding to the predicament is a dangerous location;

marking a dangerous zone in the map of the work zone based on the dangerous location.

In some embodiments, marking the dangerous zone in the map of the work zone based on the dangerous location includes:

marking a zone including the dangerous location as a dangerous zone in the map of the work zone; and/or,

obtaining a plurality of adjacent dangerous locations, and marking a zone including the plurality of adjacent dangerous locations as the dangerous zone in the map of the work zone.

In some embodiments, the method also includes:

updating a dangerous zone in a historical map based on a dangerous zone in a current map of the work zone.

In some embodiments, marking the zone including the dangerous location as the dangerous zone in the map of the work zone includes:

determining the dangerous zone based on the dangerous location;

determining a danger category of the dangerous zone;

marking the dangerous zone in the map of the work zone based on the danger category of the dangerous zone using a corresponding marking symbol.

In some embodiments, determining the danger category of the dangerous zone includes:

receiving a setting instruction from a user;

determining the danger category of the dangerous zone based on the setting instruction.

In some embodiments, the danger category of the dangerous zone may include: a high danger zone, a low danger zone.

In some embodiments, marking the dangerous zone in the map of the work zone based on the danger category of the dangerous zone using a corresponding marking symbol includes:

if the danger category of the dangerous zone is the high danger zone, marking the dangerous zone in the map of the work zone directly using the corresponding marking symbol;

if the danger category of the dangerous zone is the low danger zone, sending information relating to the dangerous zone to a user terminal for the user to determine whether to mark the dangerous zone in the map of the work zone.

In some embodiments, the method also includes:

obtaining a task;

performing route planning based on the task and the determined dangerous zone;

moving along a planned route.

In some embodiments, obtaining the sensed information acquired by the at least one sensor of the autonomous mobile device includes:

obtaining a distance acquired by an anti-drop sensor of the autonomous mobile device;

determining, based on the sensed information, whether the environmental state of the first location of the autonomous mobile device when the sensed information is obtained is a predicament, or whether the environmental state of the second location having the detecting distance from the first location of the autonomous mobile device when the sensed information is obtained is a predicament includes:

determining whether the distance is smaller than a predetermined distance;

if the distance is greater than the predetermined distance, determining the environmental state of a location of the autonomous mobile device when the distance is acquired is a predicament.

In some embodiments, obtaining the sensed information acquired by the at least one sensor of the autonomous mobile device includes:

obtaining the sensed information from a triggered wheel-drop sensor of the autonomous mobile device;

determining, based on the sensed information, whether the environmental state of the first location of the autonomous mobile device when the sensed information is obtained is a predicament, or whether the environmental state of the second location having the detecting distance from the first location of the autonomous mobile device when the sensed information is obtained is a predicament includes:

determining that the environment state of the second location of the autonomous mobile device when the wheel-drop sensor of the autonomous mobile device is triggered is a predicament.

In a second aspect, the present disclosure provides an autonomous mobile device, including:

an acquisition device configured to acquire a map of a work zone;

a motion device configured to move the autonomous mobile device in the work zone;

the acquisition device is also configured to obtain the sensed information acquired by the at least one sensor of the autonomous mobile device, the sensed information being usable to obtain an environmental state of a first location of the autonomous mobile device when the sensed information is obtained, or an environmental state of a second location of the autonomous mobile device having a detecting distance from the first location of the autonomous mobile device when the sensed information is obtained;

a processing device configured to determine whether the environmental state of the first location of the autonomous mobile device when the sensed information is obtained is a predicament, or whether the environmental state of the second location of the autonomous mobile device having the detecting distance from the first location of the autonomous mobile device when the sensed information is obtained is a predicament; if it is determined that the environmental state of the first location of the autonomous mobile device when the sensed information is obtained is a predicament, or it is determined that the environmental state of the second location of the autonomous mobile device having the detecting distance from the first location of the autonomous mobile device when the sensed information is obtained is a predicament, determining the first location or the second location corresponding to the predicament as a dangerous location;

the marking device is configured to mark a dangerous zone in the map of the work zone based on the dangerous location.

In some embodiments, when the marking device marks the dangerous zone in the map of the work zone based on the dangerous location, the marking device is specifically configured to:

marking a zone including the dangerous location as a dangerous zone in the map of the work zone; and/or,

obtaining a plurality of adjacent dangerous locations, and marking a zone including the plurality of adjacent dangerous locations as a dangerous zone in the map of the work zone.

In some embodiments, the device also includes: an updating device configured to update a dangerous zone in a historical map based on a dangerous zone in a current map of the work zone.

In some embodiments, when the marking device marks the dangerous zone in the map of the work zone based on the dangerous location, the marking device is specifically configured to:

determine the dangerous zone based on the dangerous location;

determine a danger category of the dangerous zone;

marking the dangerous zone in the map of the work zone based on the danger category of the dangerous zone using a corresponding marking symbol.

In some embodiments, when the marking device determines the danger category of the dangerous zone, the marking device is specifically configured to:

receive a setting instruction from a user;

determine the danger category of the dangerous zone based on the setting instruction.

In some embodiments, the danger category of the dangerous zone includes: a high danger zone, a low danger zone;

when the marking device marks the dangerous one in the map of the work zone based on the danger category of the dangerous zone using the corresponding marking symbol, the marking device is specifically configured to:

if the danger category of the dangerous zone is the high danger zone, directly mark the dangerous zone in the map of the work zone using the corresponding marking symbol;

if the danger category of the dangerous zone is the low danger zone, sending information relating to the dangerous zone to a user terminal for the user to determine whether to mark the dangerous zone in the map of the work zone.

In some embodiments, the acquisition device is also configured to: obtain a task;

the processing device is also configured to perform route planning based on the task and an already determined dangerous zone.

the motion device is configured to move the autonomous mobile device according to a planned route.

In some embodiments, when the acquisition device obtains the sensed information acquired by the at least one sensor of the autonomous mobile device, the acquisition device is specifically configured to:

obtain a distance acquired by an anti-drop sensor of the autonomous mobile device;

when the processing device determines, based on the sensed information, whether an environmental state of the first location of the autonomous mobile device when the sensed information is obtained is a predicament, or whether an environmental state of a second location having a detecting distance from the first location of the autonomous mobile device when the sensed information is obtained is a predicament, the processing device is specifically configured to:

determine whether the distance is smaller than a predetermined distance;

based on a determination that the distance is greater than or equal to the predetermined distance, determine the environmental state of the first location of the autonomous mobile device when the sensed information is obtained is a predicament.

In some embodiments, when the acquisition device obtains the sensed information acquired by the at least one sensor of the autonomous mobile device, the acquisition device is specifically configured to:

obtain the sensed information from a triggered wheel-drop sensor of the autonomous mobile device;

when the processing device determines, based on the sensed information, whether the environmental state of the first location of the autonomous mobile device when the sensed information is obtained is a predicament, or whether the second distance having the detecting distance from the first location of the autonomous mobile device when the sensed information is obtained is a predicament, the processing device is specifically configured to:

determine the environmental state of the first location of the autonomous mobile device as a predicament when the wheel-drop sensor of the autonomous mobile device is triggered.

In a third aspect, the present disclosure provides an autonomous mobile device, including a storage device configured to store computer program instructions; a processor configured to retrieve and execute the computer program instructions stored in the storage device, to perform the method described in the first aspect.

In a fourth aspect, the present disclosure provides a non-transitory computer-readable storage medium configured to store a computer program. When the computer program is executed by the processor, the method of the first aspect is performed.

In a fifth aspect, the present disclosure provides a computer program, including program codes. When a computer executes the computer program, the program codes execute the method of the first aspect.

In a sixth aspect, the present disclosure provides a program product. The program product includes a computer program. The computer program is stored in a non-transitory computer-readable storage medium. The processor of the autonomous mobile device may retrieve the computer program from the non-transitory computer-readable storage medium. The processor executes the computer program such that the autonomous mobile device implements the method of the first aspect.

The present disclosure provides a predicament avoidance method, an autonomous mobile device, and a storage medium. The predicament avoidance method may be implemented in the autonomous mobile device. The method includes: obtaining a map of a work zone; moving the autonomous mobile device in the work zone; obtaining sensed information acquired by at least one sensor of the autonomous mobile device, the sensed information being usable to obtain an environmental state of a first location of the autonomous mobile device when the sensed information is obtained, or an environmental state of a second location having a detecting distance from the first location of the autonomous mobile device when the sensed information is obtained; determining, based on the sensed information, whether the environmental state of the first location of the autonomous mobile device when the sensed information is obtained is a predicament, or whether the environmental state of the second location having the detecting distance from the first location of the autonomous mobile device when the sensed information is obtained is a predicament; based on a determination that the environmental state of the first location of the autonomous mobile device when the sensed information is obtained is a predicament, or that the environmental state of the second location having the detecting distance from the first location of the autonomous mobile device when the sensed information is obtained is a predicament, determining the first location or the second location corresponding to the predicament as a dangerous location; marking a dangerous zone in the map of the work zone based on the dangerous location. The autonomous mobile device may include multiple types of sensors. The autonomous mobile device may determine the operation state or the environment in which the autonomous mobile device is located when the sensed information is obtained by the autonomous mobile device. The autonomous mobile device may determine whether there is a potential danger, thereby determining whether the location of the autonomous mobile device when the sensed information is obtained by the autonomous mobile device is a dangerous location, such that a dangerous zone may be discovered in time, and the autonomous mobile device may move around the dangerous zone to avoid the dangerous zone during movements. As a result, the situation where the movement of the autonomous mobile device is blocked may be reduced or avoided, thereby increasing the work efficiency of the autonomous mobile device.

### BRIEF DESCRIPTION OF THE DRAWINGS

In order to more clearly describe the technical solutions of the present disclosure or the existing technology, the drawings referred to in the descriptions of the embodiments or the existing technology are briefly introduced below. It is understood that the drawings described below are some embodiments of the present disclosure. A person having ordinary skills in the art can obtain other drawings based on these drawings without spending creative effort.

FIG. 1 is a schematic illustration of an application scene of the present disclosure;

FIG. 2 is a flowchart illustrating a predicament avoidance method, according to an embodiment of the present disclosure;

FIG. 3 is a flowchart illustrating a predicament avoidance method, according to another embodiment of the present disclosure;

FIG. 4 is a flowchart illustrating a predicament avoidance method, according to another embodiment of the present disclosure;

FIG. 5A is a schematic illustration of a navigation according to an embodiment of the present disclosure;

FIG. 5B is a schematic illustration of a navigation according to an embodiment of the present disclosure;

FIG. 6 is a schematic structural illustration of an autonomous mobile device, according to an embodiment of the present disclosure; and

FIG. 7 is a schematic structural illustration of an autonomous mobile device, according to an embodiment of the present disclosure.

### DETAILED DESCRIPTION

In order to clearly present the objective, technical solution, and advantage of the present disclosure, next, the technical solutions of the present disclosure will be clearly and comprehensively described with reference to the drawings. It is understood that the described embodiments are merely some embodiments of the present disclosure, and are not all of the embodiments. Based on the described embodiments of the present disclosure, a person having ordinary skills in the art can derive other embodiments without spending creative effort. Such derived embodiments also fall within the scope of the present disclosure.

The term “processor” or “processing device” used herein may encompass any suitable processor, such as a central processing unit (“CPU”), a graphics processing unit (“GPU”), an application-specific integrated circuit (“ASIC”), a programmable logic device (“PLD”), or a combination thereof. Other processors not listed above may also be used. A processor may be implemented as software, hardware, firmware, or a combination thereof.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

An autonomous mobile device refers to a smart device configured to autonomously execute predetermined tasks within a predetermined zone. Currently, autonomous mobile devices include, but are not limited to, cleaning robots (e.g., smart floor sweeping devices, smart floor mopping devices, window cleaning robots, etc.), companion type mobile robots (e.g., smart electronic pets, nanny robots, etc.), service type mobile robots (e.g., reception robots for hotels, inns, meeting places), industrial inspection smart devices (e.g., power line inspection robots, smart forklifts, etc.), security robots (e.g., home use or commercial use smart guard robots), etc.

Autonomous mobile devices typically autonomously perform various tasks on a floor in a limited space. For example, cleaning robots and companion type mobile robots typically move on indoor floors, service type mobile robots typically move on floors in spaces such as hotels, meeting places, etc. The floor in the limited space may be referred to as a work zone of the autonomous mobile device.

During a movement of the autonomous mobile device, the autonomous mobile device may encounter various “predicament” in the environment. In the present disclosure, the predicament means various obstacles that may block the movement of the autonomous mobile device on the floor such that the autonomous mobile device cannot or experience difficulty escaping from a region/zone, or various protruding or depressing structures, or various obstacles or environmental situations that may cause damage to the autonomous mobile device or the floor, or bring danger to the user. A predicament in the work zone typically occupies a certain space. For example, the space a lamp base occupies is an area on the floor occupied by the lamp base. A space occupied by a desk-chair dense zone may be equivalent to a zone surrounded by outermost legs of desks and/or chairs. Therefore, the space occupied by this type of predicament forms a smallest dangerous zone. Accordingly, in the present disclosure, the location where the autonomous mobile device encounters the predicament is referred to as a dangerous location. The floor zone corresponding to the zone in which the predicament is located is referred to as a dangerous zone. For example, for objects or structures that has a drop in height, such as a step or stair, the autonomous mobile device may fall off the objects or structures, and may be damaged. Such objects or structures (e.g., step or stair) may be categorized as a type of predicament. The location of the step or stair may be categorized as a dangerous location or dangerous zone. Protruding structures that extend above the floor, such as lamp base, base of a floor fan, may cause the autonomous mobile device to be raised such that the wheels may spin freely. The lamp base and the base of the floor fan may be categorized as a type of predicament. The location of the lamp base or the base of the floor fan may be categorized as a dangerous location or a dangerous zone. Uneven and narrow gaps, such as the guiding rails of sliding doors, may cause the wheels of the autonomous mobile device to be jammed. Such uneven and narrow gaps may be categorized as a type of predicament. Smooth floors or floors with water may cause the wheels of the autonomous mobile device to slip, causing the mileage calculated by the encoding wheel to be inaccurate. Such floors can be categorized as a type of predicament. Ropes of hung objects such as window curtains that reach the floor may entangle the wheels of the autonomous mobile device and immobilize the autonomous mobile device. Such ropes may be categorized as a type of predicament. The zone where the ropes are located is a dangerous zone. Tight spaces of dense desk/chair legs, such as zones in which desks and/or chairs are densely placed adjacent a dining table or in a meeting room, may cause the autonomous mobile device to experience difficulty in escaping the tight spaces. Such desk/chair leg dense zone is a dangerous zone. For the convenience of computation, the smallest dangerous zone may be extended to a suitable extent, such that the shape of the zone is simple and easy for computation. In the meantime, with the extension of the smallest dangerous zone, it becomes not easy for the autonomous mobile device to be blocked multiple times adjacent the same location by the same predicament. Because different types of predicament may cause different types of effects, and/or different degrees of effects to the autonomous mobile device, correspondingly, the danger categories of the dangerous zone may be divided based on the danger type and/or the danger degrees or levels in the dangerous zone.

Because the size, shape, configuration of a same work zone are typically relatively fixed, and the disposition of objects within the work zone is normally not changed frequently, the locations, sizes, shapes, danger types of the obstacles or structures that cause the predicament in the same work zone may not change significantly. As a result, when the autonomous mobile device moves in the same work zone in multiple movements, the autonomous mobile device may be repeatedly stranded by the same predicament adjacent the same location for multiple times.

Based on the above issues in the existing technology, the present disclosure provides the following resolutions. In a movement of the autonomous mobile device, the autonomous mobile device determines a specific danger type based on a specific sensor parameter, and obtains the coordinates of the dangerous location that is detected and/or the location of the autonomous mobile device when the dangerous location is encountered, thereby determining a dangerous zone in the work zone. The autonomous mobile device may mark the dangerous zone in the map of the work zone, and set the dangerous zone as a forbidden zone, such that the autonomous mobile device will not enter the forbidden zone again, thereby reducing the probability of encountering the predicament by the autonomous mobile device in subsequent movement.

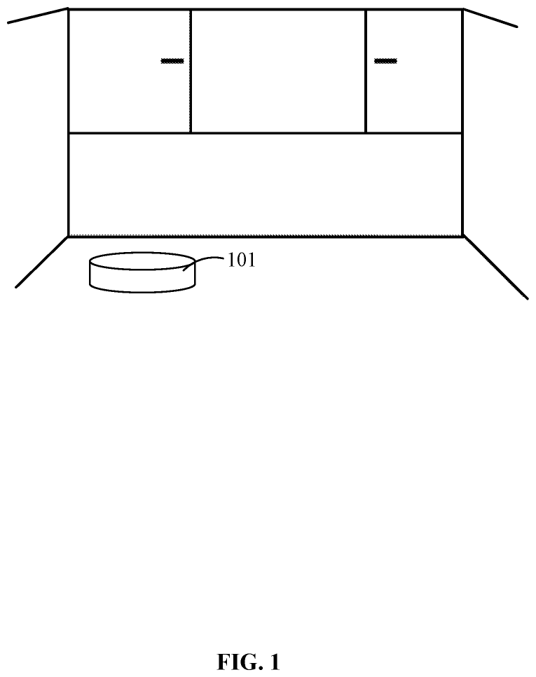

FIG. 1 is a schematic illustration of an application scene according to an embodiment of the present disclosure. As shown in FIG. 1, the autonomous mobile device may be a cleaning robot 101, which may perform indoor cleaning tasks. The cleaning robot 101 may perform the cleaning based on the cleaning tasks and according to an indoor map (i.e., the map of the work zone). During movement, the cleaning robot 101 may analyze sensor signals of various sensors to determine whether there exists a dangerous zone, and to perform real time route planning based on the detected dangerous zone, in order to avoid the predicament. The detailed implementations can refer to the following embodiments.

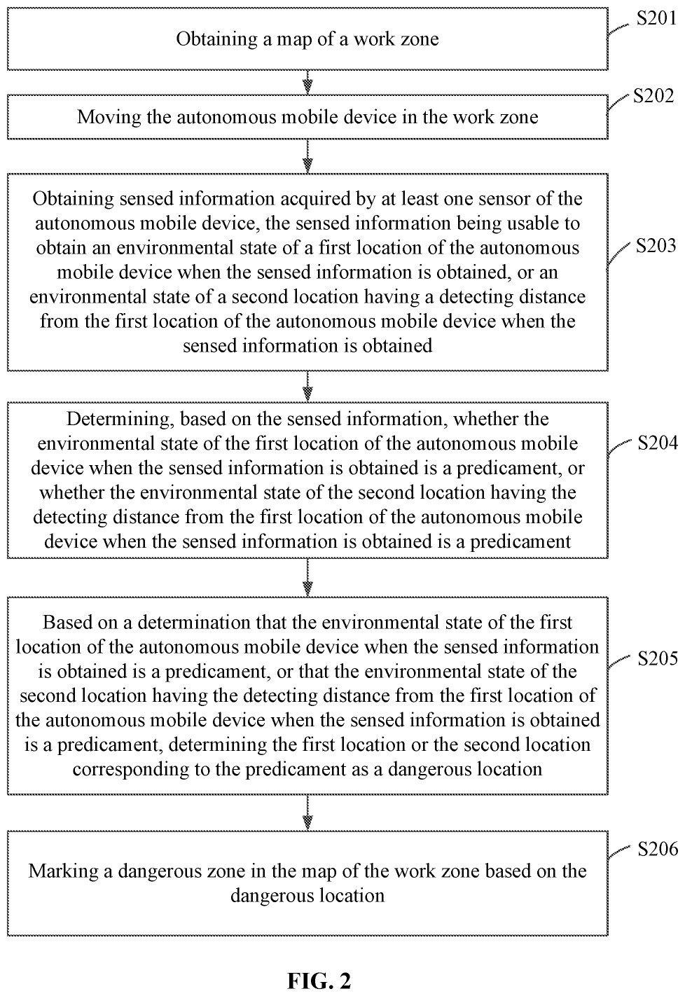

FIG. 2 is a flowchart illustrating a predicament avoidance method according to an embodiment of the present disclosure. The method of this embodiment may be implemented in the autonomous mobile device. As shown in FIG. 2, the method of this embodiment may include:

S201: obtaining a map of a work zone.

In some embodiments, the predicament avoidance method may be performed by the autonomous mobile device during the process of the autonomous mobile device moving and building a map in the work zone. The map of the work zone obtained refers to a map that is being created/constructed while the autonomous mobile device is moving. During the process of map creation, initially, all state values of all locations are set to initial values (typically consistent with the states of an unexplored zone). The autonomous mobile device moves in the work zone. When the autonomous mobile device arrives at a location, the state value of the location may be updated. Alternatively or additionally, based on a trajectory traversed by the autonomous mobile device during a period of time, the autonomous mobile device may update the state values of the coordinates traversed along the trajectory. For example, a state value of a location that is unexplored may be initially set to be 75, the state value of the coordinates corresponding to locations that are reachable and that have been traversed may be set to be 0, and the state value of coordinates corresponding to locations that are unreachable due to the blockage by obstacles may be set or updated to be 100.

As an embodiment, one method of setting the dangerous zone is to limit the dangerous zone through setting the state value of the coordinates corresponding to the dangerous location. For example, the state value of the coordinates corresponding to the dangerous location that has been recognized may be updated to be 90. With regard to the dangerous location, further detailed state values may be set to further quantify the type and/or degree of the danger. For example, the danger type may be divided into 5 types, and the state value of a dangerous location corresponding to these 5 types may be set as 91, 92, 93, 94, 95, respectively, and so forth. When the state value of the coordinates of the current location of the autonomous mobile device is 90, which means that the location is a dangerous location, or when the state value of the coordinates is between 91 and 95 corresponding to the detailed danger types, the autonomous mobile device may be controlled to stop, turn, or retreat backwardly, such that the autonomous mobile device does not enter the forbidden zone.

As an embodiment, another method for setting the dangerous zone is to draw a zone in the map of the work zone as a forbidden zone. During movement, the autonomous mobile device may determine whether the current location is within the forbidden zone. If the autonomous mobile device detects that the autonomous mobile device is near or at the boundary of the forbidden zone, the autonomous mobile device may be controlled to stop, turn, or retreat backwardly, such that the autonomous mobile device does not enter the forbidden zone. In this embodiment, it may not be needed to set the state value of the coordinates within the forbidden zone. In other words, as long as the autonomous mobile device determines that the autonomous mobile device has reached the range of the coordinates of the forbidden zone, the autonomous mobile device may not need to determine the state value of the coordinates in the forbidden zone.

In another embodiment, in a work zone that has been traversed by the autonomous mobile device and a map has been created, the predicament avoidance method may be executed separately. The map of the work zone obtained may be an already created map. An already created map (or called historical map) may be a map created by the autonomous mobile device previously and may be stored in the autonomous mobile device or in a server. Each location in the already created map has definite state value for the coordinates. For example, the state value for an unexplored location may be 75; the state value for the coordinates corresponding to a location that is reachable and has been traversed may be 0; the state value for the coordinates of the location that is unreachable due to the blockage by the obstacle may be 100. In some embodiments, the state value of the coordinates in the historical map may be different from the state value of the coordinates in the newly created map. For example, the state value of an unexplored location in the historical map may be 75; the state value of the coordinates corresponding to the location that is reachable and that has been traversed is 15; the state value of the coordinates corresponding to the location that is unreachable due to the blockage by the obstacles is 25, such that these state values are different from the counterparts in the newly created map. The present disclosure does not limit the setting rules for the state values in the newly created map and the historical map. The already created map may also be a historical map created by other autonomous mobile device(s) in previous movements in the same work zone and stored in the server. For example, there may be a floor sweeping robot and a floor mopping robot in the same home. Because these two devices perform the cleaning tasks to the floor of the same home, the work zone for the two devices is the same. The floor sweeping robot may store the map of the home that has already been created by the floor sweeping robot after completing its operation in the server. Although the floor mopping robot may have not operated in the work zone, the floor mopping robot may obtain the historical map of the work zone in the home directly from the server.

In another embodiment, the map of the work zone may be a map that has been edited by a user. For example, the user may obtain the historical map from a cloud server that has been uploaded by the autonomous mobile device. The user may edit the map by adding, changing, deleting information to or from the map, and may save the edited map. The autonomous mobile device may download the edited historical map from the server.

S202: moving the autonomous mobile device in the work zone.

The autonomous mobile device may load the map of the work zone before performing a task or during the process of performing a task. The autonomous mobile device may perform corresponding operations when reaching a marked dangerous zone. The operations include, but are not limited to, avoidance operations such as stopping and turning, and/or braking, etc. For example, the state value of the coordinates of the current location of the autonomous mobile devices may be 90, which represents a dangerous location, or when the state value of the coordinates is between 91 to 95 corresponding to the detailed danger types, the autonomous mobile device may be controlled to stop, turn, or retreat backwardly, such that the autonomous mobile device does not enter the forbidden zone. Alternatively or additionally, in the embodiment in which a zone in the map of the work zone may be designated as a forbidden zone, if during the movement the autonomous mobile device determines that the current location is near or has reached the boundary of the forbidden zone, the autonomous mobile device may be controlled to stop, turn, or retreat backwardly, such that the autonomous mobile device does not enter the forbidden zone. The user may define the corresponding operations. The autonomous mobile device may update the map of the work zone while performing tasks, such as performing addition, deletion, or modification to the original information. For example, for a location that has been reached and that has an obstacle, the state value of the coordinates of that location may be updated from the original value of 0 to 100. For a location that was marked as having an ordinary obstacle previously but is detected as a predicament now, the state value of the coordinates of that location may be updated from 100 to 90, etc.

If the loading of the map of the work zone fails, the autonomous mobile device may still create the map of the work zone in real time during the movement, and may perform corresponding operations, as described above relating to step S201.

During the process of performing the tasks or after the tasks are completed, the map of the work zone may be stored locally in the autonomous mobile device or stored remotely in a cloud server, or may be transmitted to a user for the user to perform further processing.

The autonomous mobile device may perform specific tasks autonomously in the work zone. For example, a cleaning robot may perform floor cleaning tasks in the work zone.

S203: obtaining sensed information acquired by at least one sensor of the autonomous mobile device, the sensed information being usable to obtain an environmental state of a first location of the autonomous mobile device when the sensed information is obtained, or an environmental state of a second location having a detecting distance from the first location of the autonomous mobile device when the sensed information is obtained.

During movement, the autonomous mobile device may obtain the sensed information from a sensor in real time or periodically/non-periodically based on a suitable setting. The autonomous mobile device may monitor the environmental state of the first location of the autonomous mobile device when the autonomous mobile device obtains the sensed information from the sensor, or the environmental state of the second location having a detecting distance from the first location of the autonomous mobile device when obtaining the sensed information.

The autonomous mobile device may include three types of sensors that may provide the sensed information. A first type are sensors for detecting environmental information of the location of the autonomous mobile device when the autonomous mobile device obtains the sensed information. Through the sensed information from this type of sensors, the autonomous mobile device may directly determine the environmental state of the location of the autonomous mobile device when obtaining the sensed information. For example, a collision sensor may be configured to detect whether there is an obstacle (environmental information), and may determine whether there exists an obstacle (environmental state) that blocks the movement of the autonomous mobile device at the location of the autonomous mobile device. An anti-drop sensor may be configured to detect the change in the elevation of the floor (environmental information), and may determine whether there exists a depressed floor structure such as a step adjacent the location of the autonomous mobile device, or a protruding structure extending from the floor such as a lamp base or a base of a floor fan (environmental state). A humidity sensor may be configured to detect an environmental humidity (environmental information), and may determine whether the humidity is overly high (environmental state) adjacent the location of the autonomous mobile device. An optic flow sensor may be configured to detect a change in the material of the floor (environmental information), and may determine whether the material of the floor at the location of the autonomous mobile device has changed to a material that is not suitable for floor mopping mode of a floor mopping device or a floor sweeping and mopping integrated device, such as a carpet (environmental state), etc.

A second type of sensors for providing the sensed information are sensors that derive the external environmental state based on detecting the self operation state information of the autonomous mobile device. For example, the wheel-drop sensor may derive whether a wheel set has been raised above the floor (environmental state) by detecting the state of the wheel set being compressed (the self operation state information). A current/power sensor (e.g., a resistor connected in a circuit in series, if the current value can be detected, the resistor may be used as a current sensor) mounted on a driving motor of the wheel set may be configured to detect whether the current/power of the driving motor is overly high (self operation state information), thereby determining whether the floor material at the location of the autonomous mobile device blocks the movement of the autonomous mobile device, or whether the wheel set is entangled by ropes (environmental state). By detecting whether the current/power of the driving motor is overly low (self operation state information), the autonomous mobile device may determine whether the autonomous mobile device at its location is picked up, lifted up, or slippage has occurred (environmental state), etc.

A third type of sensors that may provide sensed information are sensors configured to detect an environmental state of the second location having a detecting distance from the first location of the autonomous mobile device when the sensed information is obtained. Based on the sensed information provided by this type of sensors, the autonomous mobile device may determine the environmental state of the second location having a predetermined distance from the autonomous mobile device, which is not the current (first) location of the autonomous mobile device. for example, a proximity sensor may detect, through non-contact means, an obstacle/predicament that is within a predetermined distance from the proximity sensor (environmental information). A proximity sensor disposed at the periphery of the autonomous mobile device may detect, through horizontal detecting beams, in a non-contact manner, an obstacle/predicament (environmental information) in the environment that is within a predetermined detecting distance from the autonomous mobile device. For example, a temperature sensor or a thermal infrared sensor may be configured to detect the environmental temperature (environmental information), and may determine whether there exists a high temperature (environmental state) at a location having a detecting distance from the location of the autonomous mobile device when the sensed information is obtained.

S204: determining, based on the sensed information, whether the environmental state of the first location of the autonomous mobile device when the sensed information is obtained is a predicament, or whether the environmental state of the second location having the detecting distance from the first location of the autonomous mobile device when the sensed information is obtained is a predicament.

A single piece of sensed information or a combination of multiple pieces of sensed information may correspond to certain specific predicament(s) at the location of the autonomous mobile device. The related correspondence relationship may be pre-stored in the autonomous mobile device for later use to determine predicaments. Next, a number of sets of correspondence relationship will be described next as examples.

For example, an anti-drop sensor is typically disposed at the bottom of the autonomous mobile device and is typically downwardly facing. The anti-drop sensor is configured to detect a distance change between the bottom of the autonomous mobile device and the floor. For example, the anti-drop sensor may include an infrared diode or a time of flight (TOF) sensor. When the autonomous mobile device moves on a flat floor, the sensed information output by the anti-drop sensor typically includes constant and relatively stable values, without drastic up and down changes. When the autonomous mobile device moves on a floor that has sudden changes such as protrusion or depression (e.g., there is a sudden depression such as a stair or an apparent protruding structure such as a lamp base in front of the autonomous mobile device), the sensed information output by the anti-drop sensor may change drastically, meaning that there is a drastic height change in distance the between the anti-drop sensor and the floor. For the autonomous mobile device, if the autonomous mobile device continues to move forward, the autonomous mobile device may be jammed or the wheel set may fall. That is, the movement of the autonomous mobile device may be hindered, or the autonomous mobile device may even be damaged. Such a location is a predicament. Therefore, the location where the sensed information output by the anti-drop sensor experiences a sudden change may be determined as a type of dangerous location.

As another example, a current sensor of a wheel set and a wheel-drop sensor may together detect a dangerous zone in which the autonomous mobile device may be entangled. For example, if the window curtain has a long bottom, or a tassel or rope that extends to the floor, they may entangle the wheel set and/or the brush set of the autonomous mobile device. This type of predicament may be determined through the sensed information from the combination of the wheel-drop sensor and the current sensor. The wheel-drop sensor is connected with the wheel set. When the wheel set is in contact with the floor, the wheel set is compressed. When the autonomous mobile device is lifted up, the wheel set may drop for a specific distance due to the gravity. This may trigger the wheel-drop sensor (e.g., a micro switch or an optic coupler), thereby sensing that the autonomous mobile device is lifted up or the wheel set is hanging in the air. When the wheel-drop sensor is triggered, and when the current of the driving motor for the wheel set reduces (which means the resistance of the rotation of the wheel set is reduced), the autonomous mobile device may determine that the autonomous mobile device is away from the floor. A comparison may be made between the two wheel-drop sensors of the wheel set to determine whether both wheel-drop sensors have been triggered. If only one wheel-drop sensor is triggered, it means that only one wheel is away from the floor. This situation may be caused by one wheel being entangled by a rope, such that the wheel is lifted up. In addition, the time period during which the wheel-drop sensor is triggered may be detected. If the time period in which the wheel-drop sensor is triggered is relatively short and the wheel-drop sensor soon restored (e.g., when the time period in which the wheel-drop sensor is triggered is smaller than a predetermined time value), it is possible that the autonomous mobile device is entangled for a short period of time and the autonomous mobile device escaped the entangled state or is temporarily lifted up, and the autonomous mobile device may determine that this is not a predicament. But, if the time period in which the wheel-drop sensor is triggered is relatively long and the wheel-drop sensor does not automatically restore, the location of the autonomous mobile device may be determined to be a predicament. Alternatively or additionally, for a cleaning robot, such as a floor sweeping robot, a brush may be provided for collecting the dust on the floor. When the brush of the autonomous mobile device is entangled by the rope, the motion resistance of the brush increases, causing the output current or the output power of the driving motor of the brush to increase. Therefore, through detecting the current change in the driving motor of the brush, an auxiliary determination may be made as to whether a entangling type of predicament exists at the location of the autonomous mobile device. Another situation may be detected by the wheel-drop sensor. For example, when the autonomous mobile device is a cleaning robot, when the cleaning robot retreat backwardly or rotates, because typically the anti-drop sensor is not provided at the back or the side back, a step adjacent the current location may not be detected, and when the autonomous mobile device moves to the step, at least one wheel may fall off the step. At this moment, the wheel is hung in the air, which may trigger the wheel-drop sensor. At this moment, the chassis of the autonomous mobile device may directly touch the floor, causing damages to the chassis. Therefore, this is also a type of predicament.

As another example, the temperature sensor or the passive thermal infrared sensor may detect a high temperature zone, such as a fireplace. When the temperature sensor detects that the temperature value at a location having a detecting distance from the location of the autonomous mobile device when the sensed information is obtained exceeds a predetermined temperature value, the autonomous mobile device may determine that there exists a heat source within the detection range of the temperature sensor. An overly high temperature may degrade the performance of the autonomous mobile device. Therefore, this situation is also a predicament. The passive thermal infrared sensor may detect the thermal infrared radiation emitted by the external heat source at a location having the detecting distance from the location of the autonomous mobile device when the sensed information is obtained. When the detected thermal infrared radiation exceeds a pre-set alarming range, the high temperature predicament is also indirectly indicated.

As another example, the humidity sensor may detect a zone in which the humidity is overly high (e.g., a zone adjacent the front or side of the autonomous mobile device). An overly high humidity may cause short circuits in the autonomous mobile device or may reduce the service life of the components of the autonomous mobile device. Therefore, a zone having a humidity exceeding a predetermined humidity value (e.g., a zone on the floor having water) may be determined as a type of predicament.

As another example, an optic flow sensor installed at the bottom of the autonomous mobile device and configured to detect a distance between the bottom and the floor may detect a change in the material of the floor based on a beam emitted by the optic flow sensor and reflected/scattered back by the floor. For example, a dual-light-source optic flow sensor may be used to detect the change in the material of the floor. The dual-light-source optic flow sensor may include a laser emitting terminal and a matching laser receiving terminal, and an LED infrared light emitting terminal and a matching LED infrared receiving terminal. On a tile or word floor, a laser infrared detecting beam emitted by the laser emitting terminal of the optic flow sensor may be reflected, and the reflected beam may be received by the laser receiving terminal that is suitable positioned. On a carpet, an infrared beam emitted by the LED emitting terminal of the optic flow sensor may be scattered and the scattered beam may be received by the LED receiving terminal. Due to the softness of the carpet, mirror reflection does not occur. Therefore, the texture of different materials of the floor may be recognized through the laser and the LED of the optic flow sensor, thereby determining a location where the material of the floor changes. Through determining the change in the signal output by the optic flow sensor, the autonomous mobile device may determine that it is going to enter a zone with the carpet. For a floor mopping mode of a floor mopping device or a floor sweeping and mopping integrated device, it is desirable that the device does not move on a carpet, because the device may cause damage to the carpe. Thus, the zone covered by the carpet may be deemed as a predicament (here the predicament means that damage may be caused to the carpet, while damage or difficulty may not necessarily be caused to the autonomous mobile device). Alternatively or additionally, the change in the material of the floor may be determined based on a change in the current of the driving motor of the brush. After the autonomous mobile device moves onto a carpet, the main brush and the side brush may experience increased motion resistance on the carpet, which may cause the output current of the driving motor to increase. Therefore, the autonomous mobile device may determine that the location of the autonomous mobile device is at a “carpet” predicament through detecting the sudden change in the output power or the output current of the driving motor of the brush.

As another example, the autonomous mobile device may determine whether it encounters a desk/chair intense zone predicament based on whether a number of times of collision detected by a collision sensor disposed at the periphery (e.g., front end) of the autonomous mobile device with external obstacles exceeds a predetermined threshold value (e.g., 10 times) within a predetermined short time period (e.g., 5 minutes). In some embodiments, such type of predicament may be determined through the frequency of collision detected by the collision sensor within a predetermined time period. As such, the autonomous mobile device may at least roughly determine that the autonomous mobile device has entered a desk/chair dense zone or a narrow space having a relatively large number of obstacles.

S205: based on a determination that the environmental state of the first location of the autonomous mobile device when the sensed information is obtained is a predicament, or the environmental state of the second location having a detecting distance from the first location of the autonomous mobile device when the sensed information is obtained is a predicament, determining the first location or the second location corresponding to the predicament as a dangerous location.

If the autonomous mobile device determines, based on the sensed information, that the environmental state of the first location of the autonomous mobile device when the sensed information is obtained is a predicament, the autonomous mobile device may determine the location of the autonomous mobile device at this moment, and determine the first location or an adjacent location as a dangerous location. Because there may be a delay when the autonomous mobile device obtains the sensed information, when the autonomous mobile device obtains the processed sensed information, the autonomous mobile device may have moved forwardly for a distance. Therefore, the autonomous mobile device may not use the sensed information obtained at the previous time instance to determine the environmental state of the current location of the autonomous mobile device. However, because the motion parameters output by dead reckoning sensors (e.g., encoding wheel of the autonomous mobile device may be used to calculate the displacement, the accelerometer may be used to calculate the acceleration, the gyroscope may be used to calculate the angular velocity and angular acceleration) of the autonomous mobile device all have time stamps, and the various sensors also have time stamps when obtaining the sensed information, a corresponding relationship between the motion parameters of the dead reckoning sensors and the sensed information of the sensors may be established based on the same or similar time instance, thereby computing the environmental information and environmental state of the autonomous mobile device at a time instance when the sensed information is obtained, at a current location of the autonomous mobile device, or at a location having a detecting distance from the current location of the autonomous mobile device.

In some embodiments, the method for determining the location corresponding to the predicament may be different for different types of sensors.

Normally, the coordinates of the location of the autonomous mobile device that can be detected by the autonomous mobile device are coordinates of the location of the center point of the autonomous mobile device.

For sensors that perform detection through direct contact with the predicament, such as the collision sensor, the location of the sensor may be used as the location corresponding to the predicament. For sensors such as an anti-drop sensor, an optic flow sensor, which have a predetermined detecting distance from the predicament, but whose detecting direction is facing the floor, the coordinates of the location corresponding to the predicament may be deemed to be the coordinates of the sensor. Hence, the location of the sensor may be used as the location corresponding to the predicament. Regardless of which type of sensor is used, in some embodiments, the location of the autonomous mobile device itself may be used as the location corresponding to the predicament. For example, if the autonomous mobile device has a regular shape, such as a cylindrical shape, a square shape, a D type column shape, the geometric center in its top view shape may be used as its location. The maximum difference between the self location of the autonomous mobile device and the location of the sensors such as the collision sensor disposed at the periphery of the autonomous mobile device, the anti-drop sensor, the optic flow sensor, etc., is a radius or half of the circumference, which is negligible. That is, the self location of the autonomous mobile device may replace the location of the sensor and may be used as the location corresponding to the predicament.

In some embodiments, for sensors whose detecting direction is parallel with the floor and the predicament detected has a predetermined detecting distance from the autonomous mobile device, such as a proximity sensor or a LIDAR, the coordinates of the location corresponding to the predicament may be obtained based on the coordinates of the sensor and the detecting distance of the sensor. For an infrared diode type proximity sensor, the detecting distance is pre-set. When the distance between the predicament and the proximity sensor is within the pre-set detecting distance, the proximity sensor may transmit the sensed information. At this moment, the location corresponding to the predicament may be represented by the location of the proximity sensor (normally the pre-set detecting distance is not long, such as 6 mm). Alternatively, the actual location corresponding to the predicament may be calculated by adding the location vector of the proximity sensor and the detecting distance. For a TOF type proximity sensor (TOF is a type of LIDAR, a horizontally disposed TOF type proximity sensor may be used to measure the horizontal distance between the obstacle and the sensor in the space, this distance is the detecting distance of the TOF), if the TOF detects a predicament in the environment at a distance d from the sensor, the distance d is the detecting distance of the TOF. In the above step, the location corresponding to the predicament may be determined as a dangerous location.

S206: marking the dangerous zone in the map of the work zone based on the dangerous location.

In the work zone, the predicament is typically not a simple point. For example, for a step, the predicament is an entire zone that extends in the step direction whose boundary is the line corresponding to the edge of the sudden drop step. For a desk/chair dense zone, the predicament is the entire zone within a boundary formed by connecting the outermost desk and/or chair legs. For a high-temperature or high-humidity zone, the boundary is relatively vague, but the dangerous zone scope may be reasonably set using a predetermined threshold. Therefore, when a point of the predicament is detected, the autonomous mobile device may not use only this point as the predicament to be avoided. In order for the autonomous mobile device to not enter the locations that have not been detected at this time in the current dangerous zone, it is better to mark the entire dangerous zone corresponding to the dangerous location in the map, or to extend the dangerous location that is detected to a certain extent, to set a dangerous zone, such that the probability for the autonomous mobile device to avoid the predicament is increased.

There may be multiple methods for setting the dangerous zone. For example, the dangerous zone may be set as a circular zone using the dangerous location as the center of the circle, or as a square zone. The detailed designation method and the size of the dangerous zone may be set using empirical values in view of the properties of the sensor, or may be set based on other state of the sensor, or may be determined based on the current image information. In some embodiments, staring from a point on the boundary of the dangerous zone set as the circular zone or the square zone based on the detected dangerous location, a predetermined distance is extended in the direction from the center of the autonomous mobile device to the sensor. This point may be used as the center of a circular zone or the center of a square zone. A new extended dangerous zone may be set based on this center. The extended dangerous zone may be marked in the map of the work zone.

For example, when the anti-drop sensor detects a height change in the downward direction, there is a high probability that there is a step. A dangerous zone may be set as a circular zone or a square zone that uses the location of the autonomous mobile device when the downward height change is detected. When there are two or more anti-drop sensors, based on the detecting signals from all of the anti-drop sensors, a rough determination may be made for the relationship between the relative locations between the autonomous mobile device and the edge of the step, thereby further computing a more accurate scope. The more accurate the setting of the dangerous zone, the higher cleaning efficiency of the autonomous mobile device for the entire home.

As another example, when the temperature sensor detects a temperature change, there is a high probability that there is a fireplace or other heating generating devices. The dangerous zone may be set as a circular zone using the location where the temperature change is detected as the center (characteristics of thermal radiation of a heat source).

Alternatively or additionally, in some embodiments, in the meantime, environmental images may be recognized by an imaging device of the autonomous mobile device to determine the relationship between the relative locations of the dangerous zone and the autonomous mobile device, thereby setting the dangerous zone.

The predicament avoidance method of the present embodiment may be implemented in an autonomous mobile device. The method may include: obtaining a map of a work zone; moving the autonomous mobile device in the work zone; obtaining sensed information acquired by at least one sensor of the autonomous mobile device, the sensed information being usable to obtain the environmental state of a first location of the autonomous mobile device when the sensed information is obtained, or an environmental state of a second location having a detecting distance from the first location of the autonomous mobile device when the sensed information is obtained; determining, based on the sensed information, whether the environmental state of the first location of the autonomous mobile device when the sensed information is obtained is a predicament, or whether the environmental state of the second location having a detecting distance from the first location of the autonomous mobile device when the sensed information is obtained is a predicament; based on a determination that the environmental state of the first location of the autonomous mobile device when the sensed information is obtained is a predicament, or that the environmental state of the second location having a detecting distance from the first location of the autonomous mobile device when the sensed information is obtained is a predicament, determining the first location or the second location corresponding to the predicament as a dangerous location; marking a dangerous zone in the map of the work zone based on the dangerous location. The autonomous mobile device may include multiple types of sensors. The autonomous mobile device may determine the operation state or the environment in which is it located based on the sensed information at the time the sensed information is obtained, thereby determining whether there is potential danger facing the autonomous mobile device. Accordingly, the autonomous mobile device may determine whether the location when the sensed information is obtained by the autonomous mobile device is a dangerous location. As a result, the autonomous mobile device may discover the dangerous zone in time in advance, and may avoid the dangerous zone during movement. The situation in which the autonomous mobile device is blocked by the obstacles may be reduced. The work efficiency of the autonomous mobile device may be increased.

The order of the steps in the embodiment shown in FIG. 2 is only an example order. In some embodiments, the moving process of S202 may be executed in parallel with other steps, such as obtaining a map during movement, obtaining sensed information, determining environmental state, marking dangerous zone.

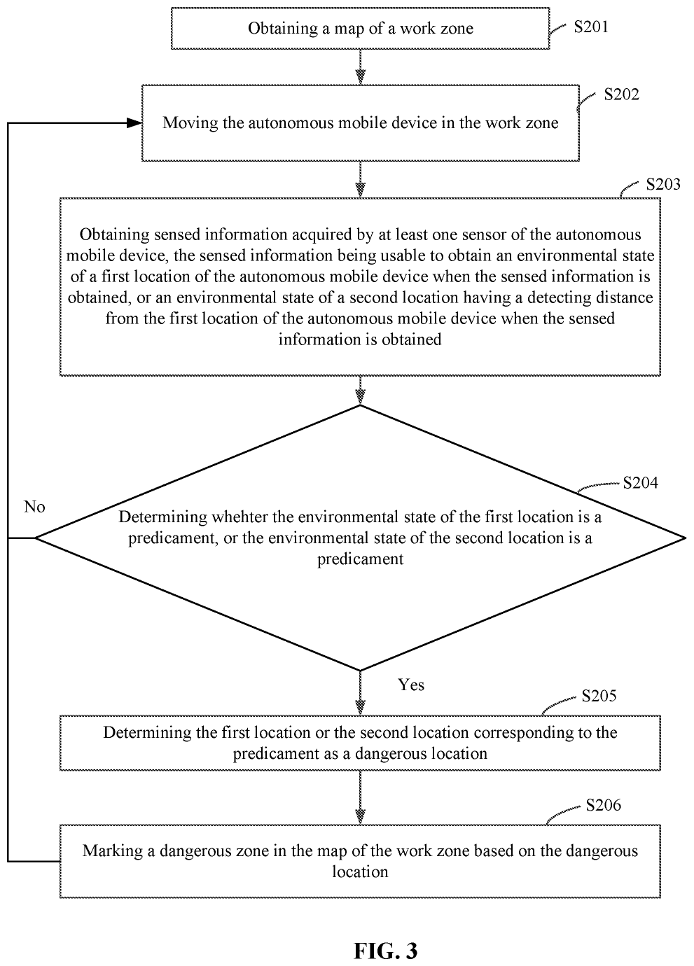

In addition, the steps S203-S206 may be repeated executed during movement of the autonomous mobile device, as shown in FIG. 3.

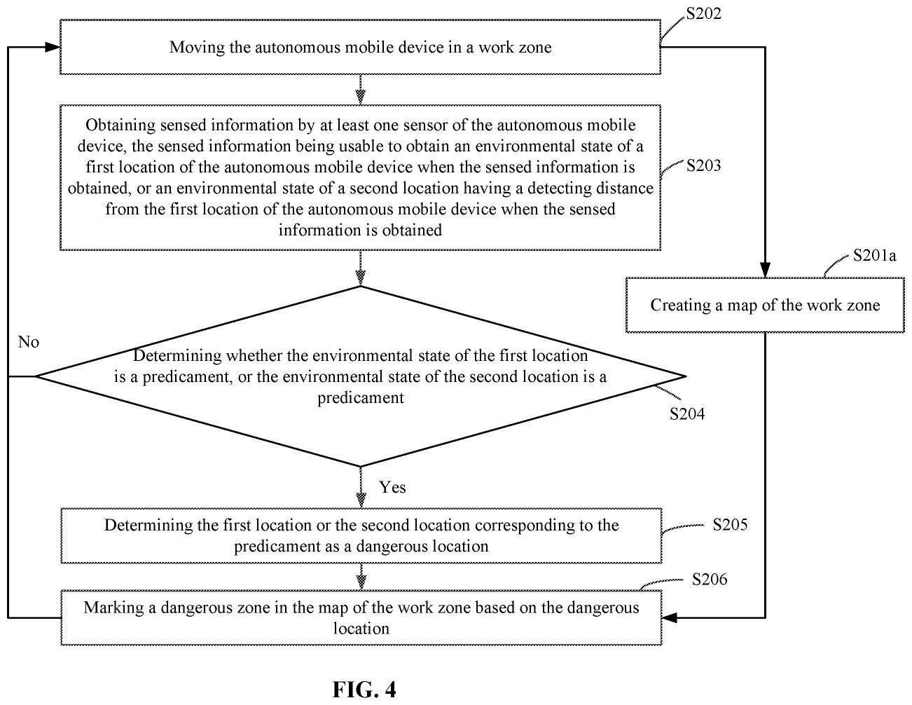

In some embodiments, if the map of the target zone is a newly created map, then during the movement, steps of creating the map of the work zone (step S201a) and marking dangerous zones may be executed, as shown in FIG. 4. The step of creating the map of the work zone may be a part of the step S201 of obtaining the map of the work zone shown in FIG. 3.

In some embodiments, the method for marking the dangerous zone in the map of the work zone based on the dangerous location, may specifically include: obtaining a plurality of dangerous locations, and marking the geometric shape formed by the plurality of dangerous locations as the boundary of the geometric shape on the map of the work zone as the dangerous zone. For example, the multiple dangerous locations may be used as points on a boundary for setting the geometric shape, and a dangerous zone may be set. Alternatively, a geometric shape may be set based on a predetermined center and an edge length/radius to surround the multiple dangerous locations, and this geometric shape may be set as the dangerous zone. In some embodiments, the multiple dangerous locations may be connected, and a maximum zone may be used as the dangerous zone.

In a practical scene, after the autonomous mobile device determines a dangerous zone using the method disclosed herein, the autonomous mobile device may re-plan a route based on the dangerous zone, to avoid the dangerous zone.

In a practical scene, after the autonomous mobile device determines a dangerous zone using the method disclosed herein, the autonomous mobile device may re-plan a route based on the dangerous zone, to avoid the dangerous zone. Because the setting of the dangerous zone by the autonomous mobile device may have certain error, the scope of the dangerous zone may be corrected using this method. For example, the autonomous mobile device may make a turn to avoid the dangerous zone. In practice, due to error, the new route planned by the autonomous mobile device may still not avoid the actual dangerous zone completely. Then, the autonomous mobile device may again detect the same type of danger. As such, the autonomous mobile device may detect multiple dangerous locations of the same type. The corrected dangerous zone may be determined as a geometric zone formed by the multiple dangerous locations as the boundary.

In some embodiments, each time when a dangerous location is determined, a corresponding dangerous zone may be set. If an overlapping part exists between the multiple dangerous zones of the same type, a dangerous zone may be further determined based on the multiple dangerous zones of the same type, which may be a maximum zone or a minimum zone, etc. The maximum zone (or a combined dangerous zone) may be a combination of the multiple dangerous zones of the same type, which may be at least partially overlapping with each other. The minimum zone may be the overlapping part of the multiple dangerous zones of the same type.

For example, if the overlapping degree between the dangerous zone currently determined and a dangerous zone previously determined within a previous time period is greater than or equal to a predetermined value, the currently determined dangerous zone and the dangerous zone previously determined within the previous time period may be combined to form a dangerous zone. The predetermined value may be ½, or any value smaller than or equal to 1 that may be set by the user.

In some embodiments, the user may set the scope of the dangerous zone. For example, after initially determining the scope of the dangerous zone or after the initially determined dangerous zone is further corrected, information about the determined dangerous zone may be sent to the user to confirm and/or manually correct.

The operations that the user may perform include:

1. Confirming the accuracy of the scope of the current dangerous zone. If the user confirms that the accuracy exceeds 95% (or any other value), the zone may not be explored for a second time in a short term; if the user confirms that the accuracy is relatively low, then the autonomous mobile device may continue to explore the zone during subsequent cleaning operations to make corrections, until the accuracy satisfies the user requirement.

2. Confirming the time period of existence for the current dangerous zone. If the user confirms that the current dangerous zone exists for a long term, then after receiving the user confirmation, the autonomous mobile device will not explore the zone for a second time in a short term; if the user confirms that the current dangerous zone exists temporarily, then the dangerous zone may be deleted after a preset expiration time, and the zone may be re-explored for correction.

3. Confirming whether the current zone is a dangerous zone. If the user confirms a dangerous zone, the marking may be preserved; otherwise, the marking may be deleted.

In some embodiments, a dangerous zone in a historical map may be updated using a dangerous zone in a current map of the work zone.

For the above-described already created map of the work zone, after the dangerous zone is confirmed in the map, the information of the dangerous zone may be updated to the historical map. Alternatively, the current map in which the dangerous zone has been confirmed may be directly stored as the map of the work zone.

In some embodiments, the method for marking the dangerous zone in the map of the work zone based on the dangerous location may include: determining the dangerous zone based on the dangerous location; determining a danger category of the dangerous zone; marking the dangerous zone in the map of the work zone using a corresponding marking symbol based on the danger category of the dangerous zone.

Division of danger categories may be based on the level of the danger, or may be based on the danger type, or may be based on any other suitable standard, which is not limited in the present disclosure.

Using division based on the level of danger as an example, specifically, the level of danger in the dangerous zone may be determined. The dangerous zone may be marked in the map of the work zone using a corresponding marking symbol based on the level of danger.

The determination of the level of danger may be made based on the sensed information provided by various sensors, or may be made by the user through manual setting. When the user manually sets the level of danger, information regarding the dangerous zone may be sent to the user through a terminal device, and the terminal device may receive the setting instructions from the user. The level of danger of the dangerous zone may be determined based on the setting instructions.

For example, for zones such as a step, a window curtain that reaches the floor, heat source, the likelihood of causing the autonomous mobile device to be stranded is high, and such zones may be set as high danger zones. For a high danger zone, automatic settings may be a default option, and may be marked on a map using a red marking symbol.

For a carpet, an intersection between the carpet and the wood or tile, a zone having a relatively high humidity, such a zone may be set as a low danger zone. For the low danger zone, the user may be notified by sending alert information to a user terminal, such that the user may determine the level of danger, or the user may select whether to set the zone as a low danger zone, which may be marked on the map using a yellow marking symbol.

For an electric wire dense zone, a desk/chair leg dense zone, because the electric wire may be a movable obstacle, the lower space under the desk, chair, or stool may need to be cleaned, and the scope of the desk/chair leg dense zone may be adjusted and is not uniquely fixed due to the desk/chair being move to change places, such a predicament may be set as an optional traverse zone. The user may be alerted to make a selection, and the zone may be set as a forbidden zone or not set as a forbidden zone based on the user selection. An orange marking symbol may be used to mark it. Or, the user may determine that the zone is a traversable zone, and a green marking symbol may be used to mark it. Or the user may determine not to mark it.

Using division of danger categories of the dangerous zones based on the danger type as an example, specifically, the danger type in the dangerous zone may be determined; based on the danger type, the dangerous zone may be marked in the map of the work zone using a corresponding marking symbol.

The determination of the danger type may be performed by the autonomous mobile device based on the sensed information.

For example, for zones such as a step, a window curtain that reaches the floor, once the autonomous mobile device is stranded, the autonomous mobile device may not be able to escape. Such zones may be set as inescapable dangerous zones. For an inescapable dangerous zone, automatic settings may be the default option, and red marking symbols may be used to mark them on the map.

For a desk/chair leg dense zone, a high humidity zone, although the autonomous mobile device may be affected to a certain extent, after performing avoidance actions, the autonomous mobile device may eventually escape such dangerous zones. Therefore, such dangerous zones may be set as escapable dangerous zones. For an escapable dangerous zone, the autonomous mobile device may send a notification to the user, for the user to select whether to set such a zone as a dangerous zone. If the user selects to set the zone as a dangerous zone, the autonomous mobile device may mark the zone on the map using a yellow marking symbol.

The method of marking may adopt the above-described color marking symbols, or may use different texts as the marking symbols. For example, the high danger zones may be marked using texts “high danger” or “big predicament.” The low danger zones may be marked using texts “low danger” or “small predicament.” These texts are merely examples. The present disclosure does not limit the marking methods.

In an embodiment, the process of determining the dangerous zone may be implemented as an independent work mode in the autonomous mobile device, such as a “predicament explore mode.” In this mode, the task of the autonomous mobile device may be determining the dangerous zones in the current work zone.

In another embodiment, the process of determining the dangerous zone may be performed simultaneously with other tasks, such as the task of creating the map of the work zone, etc. The above-described method may also include: obtaining a task; planning a route based on the task and an already determined dangerous zone; moving along the planned route.

Using a cleaning robot as an example, when performing the cleaning task, the cleaning robot may explore the dangerous zones, and in the meantime, plan the route for movement.

Typical methods of avoiding the dangerous zone may include: spring back avoidance, zig-zag avoidance, navigation avoidance, and along-boundary avoidance, etc.

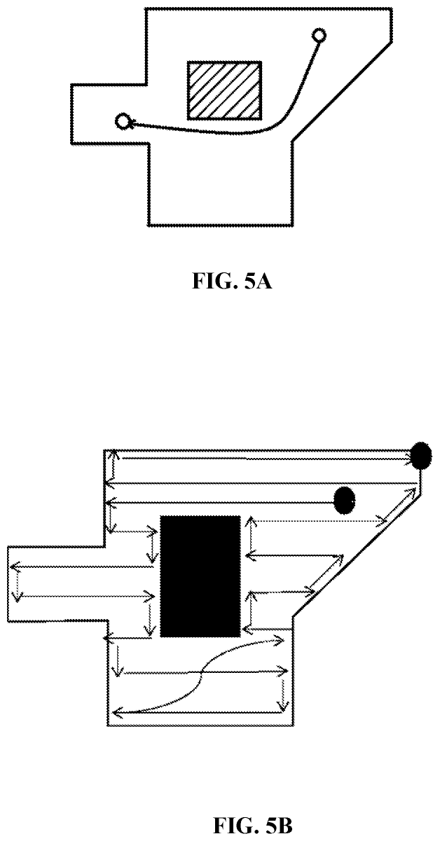

The autonomous mobile device may select an avoidance method based on the current moving mode. For example, if the autonomous mobile device is currently performing a point-to-point movement (i.e., in a navigation mode from the current location to a target location), the autonomous mobile device may re-plan the navigation route, to go around the dangerous zone, and then continue to move toward the target point in the navigation mode, as shown in FIG. 5A.

As another example, when the autonomous mobile device is currently moving in a zig-zag covering mode, the autonomous mobile device may adopt the zig-zag avoidance method to avoid the dangerous zone, and then continue to move in the zig-zag covering mode, as shown in FIG. 5B.

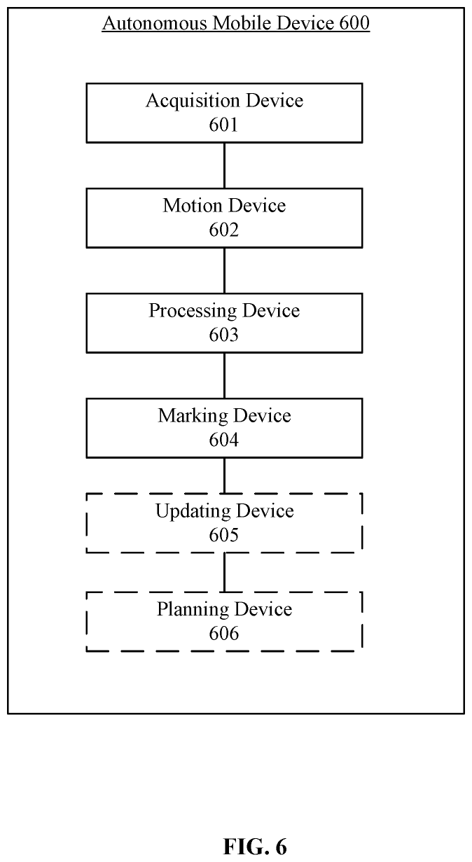

FIG. 6 is a schematic structural illustration of an autonomous mobile device, according to an embodiment of the present disclosure. As shown in FIG. 6, an autonomous mobile device 600 of the present disclosure may include: an acquisition device 601, a motion device 602, a processing device 603, a marking device 604.

The acquisition device 601 may be configured to obtain a map of a work zone.

The motion device 602 may be configured to move the autonomous mobile device in the work zone.

The acquisition device 601 may also be configured to obtain sensed information acquired by at least one sensor of the autonomous mobile device, the sensed information being usable to obtain an environmental state of a first location of the autonomous mobile device when the sensed information is obtained, or an environmental state of a second location having a detecting distance from the first location of the autonomous mobile device when the sensed information is obtained.

The processing device 603 may be configured to determine, based on the sensed information, whether the environmental state of the first location of the autonomous mobile device when the sensed information is obtained is a predicament, or whether the environmental state of the second location having a detecting distance from the first location of the autonomous mobile device when the sensed information is obtained is a predicament.

The marking device 604 may be configured to mark the dangerous zone in the map of the work zone based on the dangerous location.

In some embodiments, when the marking device 604 marks the dangerous zone in the map of the work zone based on the dangerous location, the marking device 604 may be specifically configured to:

mark a zone including the dangerous zone as a dangerous zone in the map of the work zone; and/or,

obtain a plurality of adjacent dangerous locations, and marking a zone including the plurality of adjacent dangerous locations as a dangerous zone in the map of the work zone.

In some embodiments, the autonomous mobile device 600 may also include: an updating device 605 configured to update dangerous zones in a historical map based on the dangerous zones in the current map of the work zone.

In some embodiments, when the marking device 604 marks the dangerous zone in the map of the work zone based on the dangerous location, the marking device 604 may be specifically configured to:

determine a dangerous zone based on a dangerous location;

determine a danger category based on the dangerous zone;

mark the dangerous zone in the map of the work zone using a corresponding marking symbol based on the danger category of the dangerous zone.

In some embodiments, when the marking device 604 determines the danger category of the dangerous zone, the marking device 604 may be specifically configured to:

receive a setting instruction from a user;

determine the danger category of the dangerous zone based on the setting instruction.

In some embodiments, the danger category of the dangerous zone may include: a high danger zone, a low danger zone;

When the marking device 604 determines the danger category of the dangerous zone, the marking device 604 may be specifically configured to:

if the danger category is the high danger zone, the dangerous zone may be marked in the map of the work zone directly using a corresponding marking symbol;

if the danger category is a low danger zone, the autonomous mobile device may send information relating to the low danger zone to a user terminal for a user to determine whether to mark the low danger zone in the map of the work zone.

In some embodiments, the autonomous mobile device 600 may also include a planning device 606.

The acquisition device 601 may also be configured to obtain a task.

The planning device 606 may be configured to plan a route based on the task and an already determined dangerous zone.

The motion device 602 may be configured to move the autonomous mobile device along the planned route.

In some embodiments, when the acquisition device 601 obtains the sensed information acquired by at least one sensor of the autonomous mobile device, the acquisition device 601 may be specifically configured to:

obtain a distance acquired by an anti-drop sensor of the autonomous mobile device;

when the processing device 603 determines, based on the sensed information, whether the environmental state of the first location of the autonomous mobile device when the sensed information is obtained is a predicament, or whether the environmental state of the second location having a detecting distance from the first location of the autonomous mobile device when the sensed information is obtained is a predicament, the processing device 603 may be specifically configured to:

determine whether the distance is smaller than a predetermined distance;

if the distance is greater than or equal to the predetermined distance, determine that the environmental state of the first location of the autonomous mobile device when the distance is obtained as a predicament.

In some embodiments, when the acquisition device 601 obtains the sensed information acquired by the at least one sensor of the autonomous mobile device, the acquisition device 601 may be specifically configured to:

obtain the sensed information from a triggered wheel-drop sensor of the autonomous mobile device;

when the processing device 603 determines, based on the sensed information, whether the environmental state of the first location of the autonomous mobile device when the sensed information is obtained is a predicament, or whether the environmental state of the second location having a detecting distance from the first location of the autonomous mobile device when the sensed information is obtained is a predicament, the processing device 603 may be specifically configured to:

determine that when the wheel-drop sensor of the autonomous mobile device is triggered, the environmental state of the location of the autonomous mobile device is a predicament.

The apparatus of the present disclosure may be configured to perform the method described in any of the above embodiments. The principle of implementation and technical effect may be similar, which are not described again.

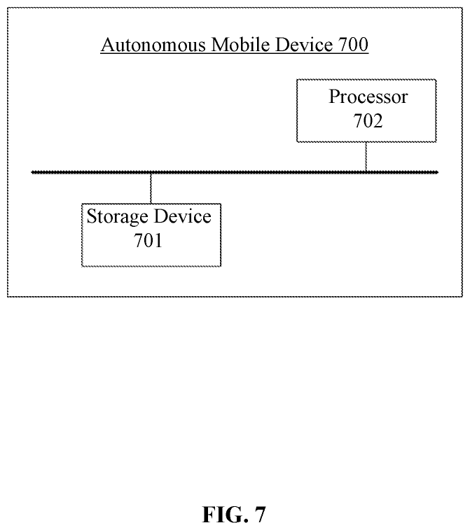

FIG. 7 is a schematic structural illustration of an autonomous mobile device according to an embodiment of the present disclosure. As shown in FIG. 7, an autonomous mobile device 700 of the present embodiment may include:

a storage device 701 configured to store program instructions;

a processor 702 configured to retrieve and execute the program instructions stored in the storage device 701, to perform the method of any of the above embodiments.

The autonomous mobile device of the present disclosure may be configured to perform the method of any of the above embodiments. The principle of implementation and technical effect may be similar, which are not described again.

The present disclosure also provides a non-transitory computer-readable storage medium. The storage medium stores a computer program. When the computer program is executed by the processor, the method of any of the above embodiments can be performed.

The present disclosure also provides a computer program, including program codes. When the computer executes the computer program, the program codes implement the method of any of the above embodiments.

A person having ordinary skills in the art can appreciate: all or some steps of the various embodiments of the methods may be realized through hardware implementing program instructions. The program may be stored in a non-transitory computer-readable medium. When the program is executed, the steps of the method of the various embodiments may be performed. The storage medium may include any suitable medium that may store program codes, such as a ROM, RAM, magnetic disk, or an optic disk.

Finally, it is worth noting that: the above embodiments are only used to describe the technical solutions of the present disclosure, and are not intended to limit the scope of the present disclosure. although the present disclosure has been described in detail with reference to the various embodiments, a person having ordinary skills in the art can appreciate: they can modify the technical solutions of the various embodiments, or can replace equivalent portions of some or all of the technical features. Such modification or replacement does not make the corresponding technical solutions fall out of the scope of the technical solutions of the embodiments of the present disclosure.

What is claimed is:

1. A method for avoiding a predicament, the method being implemented in an autonomous mobile device, and the method comprising:
obtaining a map of a work zone;
moving the autonomous mobile device in the work zone;
obtaining sensed information acquired by at least one sensor of the autonomous mobile device, the sensed information being usable to obtain an environmental state of a first location of the autonomous mobile device when the sensed information is obtained, or an environmental state of a second location having a detecting distance from the first location of the autonomous mobile device when the sensed information is obtained;
determining, based on the sensed information, whether the environmental state of the first location of the autonomous mobile device when the sensed information is obtained is a predicament, or whether the environmental state of the second location having a detecting distance from the first location of the autonomous mobile device when the sensed information is obtained is a predicament;
based on a determination that the environmental state of the first location of the autonomous mobile device when the sensed information is obtained is a predicament, or that the environmental state of the second location having a detecting distance from the first location of the autonomous mobile device when the sensed information is obtained is a predicament, determining the first location or the second location corresponding to the predicament as a dangerous location; and
marking a dangerous zone in the map of the work zone based on the dangerous location,
wherein marking the dangerous zone in the map of the work zone based on the dangerous location comprises:
determining the dangerous zone based on the dangerous location;
determining a danger category of the dangerous zone; and
marking the dangerous zone in the map of the work zone using a corresponding marking symbol based on the danger category of the dangerous zone,
wherein the danger category of the dangerous zone comprises: a high danger zone, a low danger zone, and
wherein marking the dangerous zone in the map of the work zone using a corresponding marking symbol based on the danger category of the dangerous zone comprises:
based on a determination that the danger category of the dangerous zone is the high danger zone, marking the dangerous zone in the map of the work zone directly using the corresponding marking symbol; and
based on a determination that the danger category of the dangerous zone is a low danger zone, sending information relating to the dangerous zone to a user terminal for a user to determine whether to mark the dangerous zone in the map of the work zone.

2. The method of claim 1, wherein marking the dangerous zone in the map of the work zone based on the dangerous location comprises:
marking a zone including the dangerous location as the dangerous zone in the map of the work zone; or
obtaining a plurality of adjacent dangerous locations, and marking a zone including the plurality of adjacent dangerous locations as the dangerous zone in the map of the work zone.

3. The method of claim 1, further comprising:
updating a dangerous zone in a historical map using a dangerous zone in a current map of the work zone.

4. The method of claim 1, wherein determining the danger category of the dangerous zone comprises:
receiving a setting instruction from a user; and
determining the danger category of the dangerous zone based on the setting instruction.

5. The method of claim 1, further comprising:
obtaining a task;
planning a route based on the task and an already determined dangerous zone; and
moving the autonomous mobile device along the planned route.

6. The method of claim 1, wherein obtaining the sensed information acquired by the at least one sensor of the autonomous mobile device comprises:
obtaining a distance acquired by an anti-drop sensor of the autonomous mobile device,
wherein determining whether the environmental state of the first location of the autonomous mobile device when the sensed information is obtained is a predicament, or whether the environmental state of the second location having the detecting distance from the first location of the autonomous mobile device when the sensed information is obtained is a predicament comprises:
determining whether the distance acquired by the anti-drop sensor is smaller than a predetermined distance; and
based on a determination that the distance is greater than or equal to the predetermined distance, determining an environmental state of a location of the autonomous mobile device when the distance is acquired is a predicament.

7. The method of claim 1, wherein obtaining the sensed information acquired by the at least one sensor of the autonomous mobile device comprises:
obtaining the sensed information from a triggered wheel-drop sensor of the autonomous mobile device,
wherein determining whether the environmental state of the first location of the autonomous mobile device when the sensed information is obtained is a predicament, or whether the environmental state of the second location having the detecting distance from the first location of the autonomous mobile device when the sensed information is obtained is a predicament comprises:
determining the environmental state of the first location of the autonomous mobile device when the wheel-drop sensor of the autonomous mobile device is triggered as a predicament.

8. A method for avoiding a predicament, the method being implemented in an autonomous mobile device, the method comprising:
obtaining a map of a work zone;
moving the autonomous mobile device in the work zone;
obtaining sensed information acquired by at least one sensor of the autonomous mobile device, the sensed information being usable to obtain an environmental state of a first location of the autonomous mobile device when the sensed information is obtained, or an environmental state of a second location having a detecting distance from the first location of the autonomous mobile device when the sensed information is obtained;
determining, based on the sensed information, whether the environmental state of the first location of the autonomous mobile device when the sensed information is obtained is a predicament, or whether the environmental state of the second location having a detecting distance from the first location of the autonomous mobile device when the sensed information is obtained is a predicament;
based on a determination that the environmental state of the first location of the autonomous mobile device when the sensed information is obtained is a predicament, or that the environmental state of the second location having a detecting distance from the first location of the autonomous mobile device when the sensed information is obtained is a predicament, determining the first location or the second location corresponding to the predicament as a dangerous location;
marking a dangerous zone in the map of the work zone based on the dangerous location; and
combining a plurality of dangerous zones that are of the same type and that at least partially overlap each other into a combined dangerous zone.

9. The method of claim 8, wherein combining the plurality of dangerous zones that are of the same type and that at least partially overlap each other into the combined dangerous zone comprises:
determining a geometric zone encompassing the plurality of dangerous locations of the same danger type as the combined dangerous zone.

10. The method of claim 8,
wherein the sensed information is collision information detected by a collision sensor, and
wherein determining, based on the sensed information, whether the environmental state of the first location of the autonomous mobile device when the sensed information is obtained is a predicament, or whether the environmental state of the second location having a detecting distance from the first location of the autonomous mobile device when the sensed information is obtained is a predicament comprises:
based on a determination that a number of times of collision detected by the collision sensor exceeds a predetermined threshold value, determining that the first location of the autonomous mobile device when the collision information is detected is a predicament.

11. A non-transitory computer-readable storage medium storing computer program instructions, which when executed by a processor of an autonomous mobile device, causes the autonomous mobile device to perform a method for avoiding a predicament, the method comprising:
obtaining a map of a work zone;
moving the autonomous mobile device in the work zone;
obtaining sensed information acquired by at least one sensor of the autonomous mobile device, the sensed information being usable to obtain an environmental state of a first location of the autonomous mobile device when the sensed information is obtained, or an environmental state of a second location having a detecting distance from the first location of the autonomous mobile device when the sensed information is obtained;
determining, based on the sensed information, whether the environmental state of the first location of the autonomous mobile device when the sensed information is obtained is a predicament, or whether the environmental state of the second location having a detecting distance from the first location of the autonomous mobile device when the sensed information is obtained is a predicament;
based on a determination that the environmental state of the first location of the autonomous mobile device when the sensed information is obtained is a predicament, or that the environmental state of the second location having a detecting distance from the first location of the autonomous mobile device when the sensed information is obtained is a predicament, determining the first location or the second location corresponding to the predicament as a dangerous location; and
marking a dangerous zone in the map of the work zone based on the dangerous location.

12. The non-transitory computer-readable storage medium of claim 11, wherein marking the dangerous zone in the map of the work zone based on the dangerous location comprises:
determining the dangerous zone based on the dangerous location;
determining a danger category of the dangerous zone; and
marking the dangerous zone in the map of the work zone using a corresponding marking symbol based on the danger category of the dangerous zone,
wherein the danger category of the dangerous zone comprises: a high danger zone, a low danger zone, and
wherein marking the dangerous zone in the map of the work zone using a corresponding marking symbol based on the danger category of the dangerous zone comprises:
based on a determination that the danger category of the dangerous zone is the high danger zone, marking the dangerous zone in the map of the work zone directly using the corresponding marking symbol; and
based on a determination that the danger category of the dangerous zone is a low danger zone, sending information relating to the dangerous zone to a user terminal for a user to determine whether to mark the dangerous zone in the map of the work zone.

13. The non-transitory computer-readable storage medium of claim 12, wherein marking the dangerous zone in the map of the work zone based on the dangerous location comprises:
marking a zone including the dangerous location as the dangerous zone in the map of the work zone; or
obtaining a plurality of adjacent dangerous locations, and marking a zone including the plurality of adjacent dangerous locations as the dangerous zone in the map of the work zone.

14. The non-transitory computer-readable storage medium of claim 12, wherein the method further comprises:
updating a dangerous zone in a historical map using a dangerous zone in a current map of the work zone.

15. The non-transitory computer-readable storage medium of claim 12, wherein determining the danger category of the dangerous zone comprises:
receiving a setting instruction from a user; and
determining the danger category of the dangerous zone based on the setting instruction.

16. The non-transitory computer-readable storage medium of claim 12, wherein the method further comprises:
obtaining a task;
planning a route based on the task and an already determined dangerous zone; and
moving the autonomous mobile device along the planned route.

17. The non-transitory computer-readable storage medium of claim 12, wherein obtaining the sensed information acquired by the at least one sensor of the autonomous mobile device comprises:
obtaining a distance acquired by an anti-drop sensor of the autonomous mobile device,
wherein determining whether the environmental state of the first location of the autonomous mobile device when the sensed information is obtained is a predicament, or whether the environmental state of the second location having the detecting distance from the first location of the autonomous mobile device when the sensed information is obtained is a predicament comprises:
determining whether the distance acquired by the anti-drop sensor is smaller than a predetermined distance; and
based on a determination that the distance is greater than or equal to the predetermined distance, determining an environmental state of a location of the autonomous mobile device when the distance is acquired is a predicament.

18. The non-transitory computer-readable storage medium of claim 11, wherein obtaining the sensed information acquired by the at least one sensor of the autonomous mobile device comprises:
obtaining the sensed information from a triggered wheel-drop sensor of the autonomous mobile device,
wherein determining whether the environmental state of the first location of the autonomous mobile device when the sensed information is obtained is a predicament, or whether the environmental state of the second location having the detecting distance from the first location of the autonomous mobile device when the sensed information is obtained is a predicament comprises:
determining the environmental state of the first location of the autonomous mobile device when the wheel-drop sensor of the autonomous mobile device is triggered as a predicament.

19. The non-transitory computer-readable storage medium of claim 11, wherein the method further comprises: combining a plurality of dangerous zones that are of the same type and that at least partially overlap each other into a combined dangerous zone.

20. The non-transitory computer-readable storage medium of claim 19, wherein combining the plurality of dangerous zones that are of the same type and that at least partially overlap each other into the combined dangerous zone comprises:
determining a geometric zone encompassing the plurality of dangerous locations of the same danger type as the combined dangerous zone.
